(19) United States
(12) Patent Application Publication
(10) Pub. No.: US 2019/0320684 A1
(43) Pub. Date: Oct. 24, 2019

(54) A WHEAT BRAN FRACTION FOR USE TO COMBAT SALMONELLA INFECTION

(71) Applicants: Universiteit Gent, Gent (BE); Katholieke Universiteit Leuven, Leuven (BE)

(72) Inventors: Filip Van Immerseel, Eke (BE); Richard Ducatelle, Wortegem-Petegem (BE); Tom Van De Wiele, Merelbeke (BE); Karen Vermeulen, Gent (BE); Christophe Courtin, Wilsele (BE); Joran Verspreet, Heverlee (BE)

(21) Appl. No.: 16/314,588

(22) PCT Filed: Jul. 6, 2017
(86) PCT No.: PCT/EP2017/067028

§ 371 Date: Dec. 31, 2018

(30) Foreign Application Priority Data
Jul. 8, 2016 (EP) 16178623.1

(51) Int. Cl. A23K 10/37; A23K 50/75

(52) U.S. Cl. CPC A23K 10/37; A23K 50/75

(57) ABSTRACT

A method of reducing human salmonellosis due to consumption of contaminated food. More in particular this application discloses a specific wheat bran fraction that reduces colonization of Salmonella bacteria in the gut of animals that are part of the human food chain. This disclosure indeed demonstrates that animals such as broilers that are given feed supplemented with the latter feed bran fraction—and are then infected with Salmonella—have a significantly reduced number of Salmonella bacteria in their cecum and shed less bacteria in their environment when compared to control animals that are given non-supplemented feed.

### CROSS-REFERENCE TO RELATED APPLICATIONS

This application is a national phase entry under 35 U.S.C. § 371 of International Patent Application PCT/EP2017/067028, filed Jul. 6, 2017, designating the United States of America and published in English as International Patent Publication WO 2018/007562 A1 on Jan. 11, 2018, which claims the benefit under Article 8 of the Patent Cooperation Treaty to European Patent Application Serial No. 16178623.1, filed Jul. 8, 2016.

### TECHNICAL FIELD

This application discloses a method of reducing human salmonellosis due to consumption of contaminated food. More in particular, this application discloses a specific wheat bran fraction that reduces colonization of Salmonella bacteria in the gut of animals that are part of the human food chain. This disclosure indeed demonstrates that animals such as broilers that are given feed supplemented with the latter feed bran fraction, and are then infected with Salmonella, have a significantly reduced number of Salmonella bacteria in their cecum and shed less bacteria in their environment when compared to control animals that are given non-supplemented feed.

### BACKGROUND

Dietary fibers (DF) are carbohydrate polymers and oligomers that escape digestion in the small intestine and pass into the hindgut where they are (partially) fermented. Current classification systems are based on physicochemical properties such as water-holding capacity, viscosity and the degree to which they are fermented by the microbial gut community.^{[1-3]} These physicochemical properties can be altered by processing.^{[4,5]} Based on the reaction with water, DF can be classified as either soluble or insoluble.^{[6]} In general, water-insoluble DF (such as cellulose, lignin and some hemicelluloses) are thought to be less fermentable, while water-soluble DF (such as pectin) mostly are fermentable.^{[1-3]} A significant part of the beneficial health effects attributed to DF consumption is believed to arise from their fermentation) There is, however, not always a clear relationship between DF solubility and fermentability.^{[8,9]} For example, it has been shown that some insoluble DF such as cellulose can be fermented and affect host health.^{[10-12]} So both soluble and insoluble DF can have effects on gut health.^{[8,9]} The consumption of DF is generally believed to be beneficial for intestinal health. The ingestion of soluble DF such as arabinoxylooligosaccharides (AXOS), can strengthen the integrity of the mucus layer and gut epithelium through the production of short chain fatty acids (SCFA). Butyric acid has been proposed as the SCFA of greatest importance. It is a major energy source for colonocytes and is known to have anti-inflammatory effects, to reinforce various components of the mucosal barrier and to modulate oxidative stress.^{[13, 14]} Wheat bran is recognized to be a highly concentrated source of insoluble fiber and consists of both fermentable and non-fermentable DF.^{[15]} Wheat bran is an abundantly available by-product from the milling of wheat into flour. It constitutes 14%-16% of the wheat kernel and comprises the outer coverings (pericarp), the aleurone layer and remnants of starchy endosperm.^{[16-18]} The main DF present are glucuronoarabinoxylans linked to other macromolecules (such as lignin, proteins or both), cellulose and mixed linked (1-3),(1-4)β-D-glucans, constituting, respectively, 70%, 24% and 6% of total wheat bran DF.^{[19]} These arabinoxylans and β-glucans are water-insoluble.^{[19]} Besides DF, starch (10%-20%), proteins (15%-22%) and lignin (4%-8%) are the predominant chemical constituents of the wheat bran.^{[17]}

Nutritional interventions have been shown to be useful tools to reduce colonization of the chicken gut with pathogens. The intake of wheat bran-derived AXOS by chickens, for example, can increase the resilience against pathogens such as Eimeria and Salmonella.^{[18, 20, 21]} Although the number of human salmonellosis cases is decreasing in many regions worldwide, Salmonella remains an important zoonotic agent of global importance.^{[22]} As human salmonellosis cases are often the consequence of the consumption of contaminated food products derived from animals, control of Salmonella in food-producing animals remains important. Different approaches to control Salmonella using feed additives have already been investigated, many of which gave highly variable results. These include organic acids, probiotics, competitive exclusion products, and a variety of prebiotics.^{[20,23-25]}

However, there is still a need to search for alternative and effective products and processes that significantly reduce Salmonella colonization in food animals.

### BRIEF SUMMARY

As Salmonella control in the live phase of meat production is an important aspect of Salmonella control programs in Europe, the present disclosure relates to much needed substances that protect animals from Salmonella colonization.

More specifically, this disclosure relates to a wheat bran fraction with a mass-based average particle size ranging between 273 and 283 μm for use to reduce colonization of bacteria belonging to the genus Salmonella in the gut of an animal.

Even more specifically, this disclosure relates to a wheat bran fraction as described above wherein the mass-based average particle size is 278 μm.

Moreover, this disclosure relates to a wheat bran fraction as described wherein the animal is a chicken and, more specifically, wherein the chicken is a broiler.

The disclosure further relates to a wheat bran fraction as described above wherein the bacteria belong to the species Salmonella enteritidis.

Moreover, this disclosure relates to a wheat bran fraction as described above wherein the gut is the cecum.

In addition, the disclosure relates to feed supplemented with a wheat bran fraction as described above for use to combat Salmonella infections in animals. In other words, this disclosure relates to a wheat bran fraction as described above for use to reduce colonization of bacteria belonging to the genus Salmonella in the gut of an animal, wherein the wheat bran fraction is formulated as a supplement in feed.

More specifically, the disclosure relates to feed supplemented with a wheat bran fraction as described above wherein the wheat bran fraction maximally represents 5% of the total weight of the feed and, even more specifically, wherein the wheat bran fraction represents 1% of the total weight of the feed.

In other words, this disclosure also relates to a method to reduce Salmonella infections in animals comprising administering an effective amount of a wheat bran fraction as indicated above or an effective amount of feed as described above to an animal in need thereof.

### BRIEF DESCRIPTION OF THE DRAWINGS

FIG. 1. Mass-based cumulative particle size distributions of wheat bran. Pre-sieved coarse wheat bran had a mass-based average particle size (day) of 1687 μm. The day of this material was ultimately reduced down to 77 μm. Adapted from Jacobs et al. (2015).^{[26]}

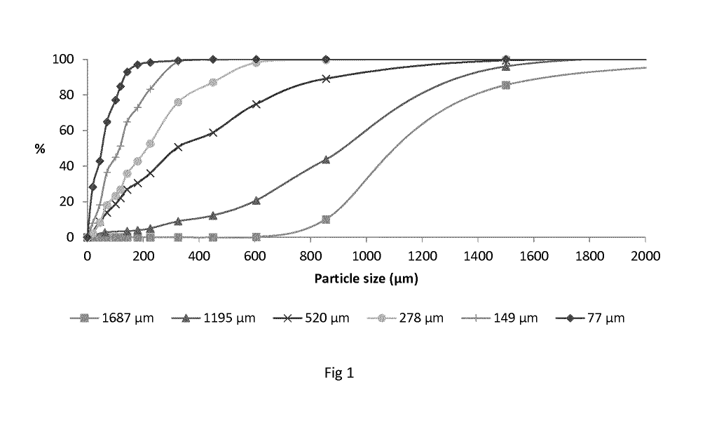

FIG. 2. Cecal colonization by Salmonella enteritidis (SE147). All chickens (n=20) were inoculated with 10⁶ CFU Salmonella enteritidis (SE147) on day 10 of the experiment. On dpi+4, the chickens were euthanized and Salmonella counts in cecum were determined. The different bran fractions are depicted on the x-axis while the y-axis shows log of the number of colony-forming units per gram cecum. Horizontal lines represent the mean log value (CFU/g tissue); error bars represent the standard deviation. The dotted line indicates the detection limit prior to enrichment. *0.01≤p≤0.05; **p≤0.01

FIG. 3. The number of total Bacteria (Panel A) and butyryl-CoA:acetate-CoA transferase gene copies (Panel B) in cecal contents obtained from broilers fed different wheat bran fractions. Ten chickens per group were sampled. Each group received a standard feed supplemented with 1% of a bran fraction, which is indicated on the x-axis. Horizontal lines represent the mean log value (copy number/g wet content); error bars represent the standard deviation. *0.01≤p≤0.05; **p≤0.01

FIG. 4. Cecal colonization by Salmonella enteritidis strain SE147 after experimental infections of broilers being fed different wheat bran fractions. In every group, one chicken in five (n=12) was inoculated with 10⁸ CFU of Salmonella enteritidis strain SE147 when they were 10 days old. On dpi+4, dpi+18 and dpi+32, 20 chickens were euthanized in each group and Salmonella counts in the ceca were determined. The results are shown per autopsy day (x-axis). The y-axis shows the Salmonella counts per gram cecum. Horizontal lines represent the mean log value (CFU/g tissue); error bars represent the standard deviation. The dotted line indicates the enrichment level. ⋅ control, ▪ 1687 μm, ▴ 278 μm. **0.001≤p≤0.01

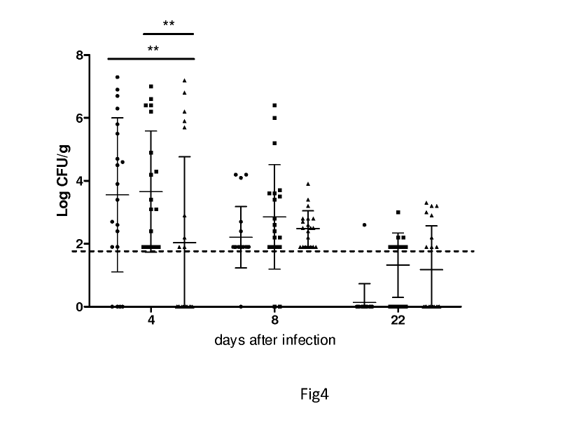

FIG. 5. Amounts of total SCFA (Panel A), acetic acid (Panel B), propionic acid (Panel C) and butyric acid (Panel D) produced during in vitro fermentations of wheat bran with different particle sizes. Supernatant of the in vitro fermentations was collected after 24 hours. Total amount of SCFA was calculated as the sum of acetic, propionic and butyric acid. Bars represent the mean; error bars represent the standard deviation. *0.01≤p≤0.05; **p≤0.01

FIG. 6. Relative expression of the hilA gene after exposure of Salmonella enteritidis hilA-lux or rpsM-lux fusion construct strains to in vitro fermented wheat bran fractions (y-axis). Overnight cultures of Salmonella enteritidis strain SE147 carrying a plasmid containing either hilA-luxCDABE or rpsM-luxCDABE transcriptional fusions were diluted 1:100 in LB medium supplemented with supernatant (1:1) derived from, respectively, the fermentation without bran (control), with unmodified bran (1687 μm), and bran with reduced particle size (278 μm) (x-axis). The diluted cultures were grown in microplates at 37° C. for 15 hours. Horizontal lines represent the mean; error bars represent the standard deviation. Data represents the measurement after 15 hours of incubation. **0.001≤p≤0.01; *** p≤0.001

FIG. 7. Effect of particle size on the ability of Salmonella to invade host cells. Salmonella enteritidis bacteria were pre-incubated for 15 hours at 37° C. in LB medium supplemented with supernatant (1:1) derived from one of three fermentation reactions in which no bran (control), unmodified bran (1687 μm), and bran with reduced particle size (278 μm) were added. Hereafter, an invasion assay was performed. Invasion was calculated as the percent invaded bacteria relative to the initial number of inoculated bacteria (y-axis). The different bran fractions are depicted on the x-axis. Horizontal lines represent the mean; error bars represent the standard deviation. *0.01≤p≤0.05; **p≤0.01

### DETAILED DESCRIPTION

The disclosure relates to a wheat bran fraction with a mass-based average particle size ranging between 273 μm and 283 μm for use to reduce colonization of bacteria belonging to the genus Salmonella in the gut of an animal.

The term “wheat bran” relates to an abundantly available by-product from the milling of wheat into flour. It constitutes 14%-16% of the wheat kernel and comprises the outer coverings (pericarp), the aleurone layer and remnants of starchy endosperm.^{[16-18]} Wheat bran is recognized to be a highly concentrated source of insoluble fiber and consists of both fermentable and non-fermentable DF.^{[15]} The main DF present are glucuronoarabinoxylans linked to other macromolecules (such as lignin, proteins or both), cellulose and mixed linked (1-3),(1-4)-β-D-glucans, constituting, respectively, 70%, 24% and 6% of total wheat bran DF.^{[19]} These arabinoxylans and β-glucans are water-insoluble.^{[19]} Besides DF, starch (10%-20%), proteins (15%-22%) and lignin (4%-8%) are the predominant chemical constituents of the wheat bran.^{[17]}

The term “fraction with a mass-based average particle size ranging between 273 μm and 283 μm” relates in essence to a fraction with a mass-based average particle size of about 278 μm. The term “about” relates to a mass-based average particle of 278 μm+/−5 μm or, in other words, to a mass-based average particle size ranging between 273 μm and 283 μm. The particle size of wheat bran can be reduced as described.^{[26]} In short, any wheat bran such as commercial wheat bran (Dossche Mills, Deinze, Belgium) can be reduced in particle size with a Cyclotec 1093 Sample mill (FOSS, Hoganäs, Sweden). By changing the grinding ring and/or the mesh size of the final sieve of the mill, bran fractions with differing particle sizes are obtained. The particle size distribution of the resulting fractions is determined by sieving 20.0 g of bran on a set of sieves with mesh sizes of 4500, 2000, 1000, 710, 500, 400, 250, 200, 160, 125, 112, 90, 50, and 38 μm. The set of sieves is shaken for 30 minutes at a frequency of 1.5 with a retch Vibratory Sieve Shaker (Aartselaar, Belgium) and each sieve is gently brushed to avoid clogging of the sieve pores. The mass of the bran that remained on each sieve is determined and used to calculate the “mass-based average particle size”:

dₐᵥ=Σdᵢ·mᵢ

with dᵢ=(upper size limit of bran fraction i+lower limit of bran fraction i)/2 and mᵢ=mass fraction, i.e., mass on sieve i/sum of masses of all fractions.

Regular wheat bran (1687 μm) and wheat bran with average particle sizes of 1195 μm, 520 μm, 278 μm, 149 μm and 77 μm are used in the experiments disclosed by this disclosure.

The terms “to reduce colonization of bacteria belonging to the genus Salmonella in the gut of an animal” relates to the fact that the specific bran fraction of this disclosure, when administered to animals infected with Salmonella, significantly (i.e., p≤0.05) decreases the number of colony-forming units (CFU) per gram gut of the animal.

The term “genus Salmonella” relates to the well-known bacterial genus Salmonella that comprises, for example, the well-known species Salmonella enteritidis (which is also described as “Salmonella enterica subspecies enterica serovar Enteritidis” (see, for example, Wisner et al., Microbiology 2010: 2770-2781)) that, in its turn, comprises, for example, the strain Salmonella enteritidis phage type 4 strain 147 (SE147) as previously described.^{[21]}

The term “animal” relates in principle to any animal that can be infected by Salmonella and can be or is consumed by humans. The term “specifically” relates to poultry or any domesticated birds such as, but not limited to, chickens, ducks, geese, turkeys and quail, but also relates to pigs, wild-boar and others. The term “animal” further specifically relates to Broiler chickens (Gallus gallus domesticus), or broilers, that are a gallinaceous domesticated fowl, bred and raised specifically for meat production. Typical broilers have white feathers and yellowish skin. Most commercial broilers reach slaughter weight at between five and seven weeks, or at a minimum of eight weeks of age with regard to the so-called “slow-growing broilers.” Because the meat broilers are this young at slaughter, their behavior and physiology are that of an immature bird.

Hence, this disclosure further relates to a wheat bran fraction as indicated wherein the mass-based average particle size is 278 μm.

Moreover, the present disclosure relates to a wheat bran fraction as indicated above wherein the animal is a chicken and, more specifically, wherein the chicken is a broiler.

This disclosure further relates to a wheat bran fraction as indicated above wherein the bacteria belong to the species Salmonella enteritidis.

The present disclosure further relates to a wheat bran fraction as indicated above wherein the gut is the cecum as the cecum is a specific part of the animal's gut where most fermentation of the wheat bran fraction of this disclosure occurs.

In addition, the present disclosure relates to feed supplemented with a wheat bran fraction as described above for use to combat Salmonella infections in animals. In other words, the disclosure relates to a wheat bran fraction as described above for use to combat Salmonella infections in animals, wherein the wheat bran fraction is formulated as a supplement in feed.

The term “feed” refers to any kind of food given to domestic animals.

More specifically, this disclosure relates to feed supplemented with a wheat bran fraction as described above wherein the wheat bran fraction maximally represents 5% of the total weight of the feed even more specifically wherein he wheat bran fraction represents 1% of the total weight of the feed. The terms “maximally represents 5%” indicate that the weight of the wheat bran fraction represents 5, 4, 3, 2, 1 or less % of the total weight of the feed administered to an animal.

In other words, the disclosure also relates to a method to reduce Salmonella infections in animals comprising administering an effective amount of a wheat bran fraction as indicated above or an effective amount of feed as described above to an animal in need thereof.

### EXAMPLES

### Materials and Methods

### Bacterial Strains.

The streptomycin-resistant Salmonella enteritidis phage type 4 strain 147 (SE147) was used in both in vivo and in vitro experiments. This strain was originally isolated from egg white and is known to colonize the chicken gut and internal organs to a high extent.^{[27]}

### Modified Wheat Bran Fractions.

The particle size of wheat bran was reduced as described previously.^{[26]} In short, commercial wheat bran (Dossche Mills, Deinze, Belgium) was reduced in particle size with a Cyclotec 1093 Sample mill (FOSS, Höganäs, Sweden). By changing the grinding ring and/or the mesh size of the final sieve of the mill, bran fractions with differing particle sizes were obtained. The particle size distribution of the resulting fractions was determined by sieving 20.0 g of bran on a set of sieves with mesh sizes of 4500, 2000, 1000, 710, 500, 400, 250, 200, 160, 125, 112, 90, 50, and 38 μm. The set of sieves was shaken for 30 minutes at a frequency of 1.5 with a retch Vibratory Sieve Shaker (Aartselaar, Belgium) and each sieve was gently brushed to avoid clogging of the sieve pores. The mass of the bran that remained on each sieve was determined and used to calculate a mass-based average particle size:

dₐᵥ=Σdᵢ·mᵢ

with dᵢ=(upper size limit of bran fraction i+lower limit of bran fraction i)/2 and mᵢ=mass fraction, i.e., mass on sieve i/sum of masses of all fractions.

Regular wheat bran (1687 μm) and wheat bran with average particle sizes of 1195 μm, 520 μm, 278 μm, 149 μm and 77 μm were used in the experiments described below.

### Animals.

One-day-old Ross 308 broilers were obtained from a local hatchery and housed in containers on wood shavings. A commercial standard basis ration and drinking water were provided ad libitum. Experiments were performed with the permission of the Ethical Committee of the Faculty of Veterinary Medicine, Ghent University, Belgium (EC 2014/76 & EC 2014/146).

The nutrient composition of the administered feed was the following:

Nutrient composition

| | |
|---|---|
| Crude protein | 21.0% |
| Crude fat | 6.0% |
| Crude ash | 5.5% |
| Crude fiber | 3.0% |
| Lysine | 1.17% |
| methionine | 0.52% |
| Calcium | 0.85% |
| Phosphorus | 0.58% |
| Sodium | 0.15% |

### Experiment 1: The Effect of Wheat Bran with Different Average Particle Sizes in a Salmonella Infection Model

To evaluate the effect of the average particle size of wheat bran on the colonization of Salmonella in chickens, 210 one-day-old chicks were divided into seven groups of thirty animals. The feed of each group was supplemented with one percent of the different wheat bran fractions, i.e., unmodified bran (1687 μm) or bran with average reduced particle size of 1195 μm, 520 μm, 275 μm, 149 μm or 77 μm. The control group received non-supplemented feed. At the age of 10 days, twenty chickens per group were given 10⁶ CFU of the SE147 challenge strain by oral gavage. The remaining ten chickens in each group were euthanized to collect cecal contents in order to determine the number of butyric acid-producing bacteria present. Shedding of the SE147 challenge strain was monitored by taking cloacal swabs on day 1 post-infection (dpi+1) and dpi+3. On dpi+4, the chickens were euthanized and Salmonella counts in cecum were determined. Cloacal swabs were also collected on dpi-1 to ensure that all chickens were Salmonella negative prior to experimental infection.

### Experiment 2: Confirmation of the Effects of a Wheat Bran Fraction with an Average Reduced Particle Size of 278 μm in a Salmonella Seeder Bird Infection Model

A seeder bird model was used to evaluate the effect of bran with reduced particle size on Salmonella infection in broilers. Seeder bird models allow the infection to spread in a more natural way. One hundred eighty one-day-old chicks were divided into three groups of sixty animals. The feed of the animals in the treatment groups was supplemented with 1% unmodified wheat bran (1687 μm) or 1% wheat bran with an average reduced particle size of 278 μm. The control group received non-supplemented feed. On day 10, 12 chickens in each group (one chicken out of five) received 10⁸ CFU of the Salmonella enteritidis SE147 challenge strain by oral gavage. These seeder birds were marked using leg rings in order to be able to distinguish them from non-seeder birds. Shedding of the SE147 challenge strain was monitored by collecting cloacal swabs on days dpi+1, dpi+3, dpi+8, dpi+15, dpi+22 and dpi+29. Cloacal swabs were also collected prior to inoculation to verify that none of the animals were already infected with Salmonella prior to onset of the experiment. On day dpi+4, dpi+18 and dpi+32, 20 chickens were euthanized in each group and Salmonella counts in cecum were determined.

### Bacteriological Analysis.

Cloacal swabs were directly inoculated on Xylose Lysine Deoxycholate agar (XLD, Oxoid, Basingstoke, England) plates supplemented with 100 μg/ml streptomycin (Sigma-Aldrich, St. Louis, Mo., USA). Negative samples were pre-enriched in buffered-peptone water (BPW, Oxoid, Basingstoke, England) overnight at 37° C. One ml of this suspension was enriched by adding 9 ml of tetrathionate-brilliant green broth (Merck, Darmstadt, Germany). After another overnight incubation period at 37° C., the suspension was plated onto XLD supplemented with 100 μg/ml streptomycin.

Cecal samples were diluted ten times and homogenized in BPW, after which ten-fold dilutions were made in phosphate-buffered saline (PBS). For each dilution, six droplets were plated onto XLD plates supplemented with 100 μg/ml streptomycin. These plates were then incubated overnight at 37° C. The number of CFU/g tissue was determined by counting the number of colonies on the plates. Samples negative after direct plating were enriched as described above. Samples negative after direct plating but positive after enrichment were assumed to contain 1×10¹ CFU/g cecum. Samples negative after enrichment were considered to be negative. Salmonella counts were log transformed. Statistical analysis was done with SPSS Statistics 23 (IBM Corp, New York, United States), using a Kruskall-Wallis test to determine statistical differences in the number of Salmonella positive cloacal swabs and cecal Salmonella counts between groups.

qPCR Analysis to Quantify Butyryl-CoA:Acetate-CoA Transferase Gene Copies.

DNA was extracted from cecal contents using the CTAB method as described previously.^{[28]} Subsequently, qPCR was used to quantify the number of total bacteria and butyryl-CoA:acetate-CoA transferase genes in the samples using the respective primer pairs: Uni 331F (5′-TCCTACGGGAGGCAGCAGT-3′) (SEQ ID NO:1), Uni 797R (5′-GGACTAACCAGGGTATCTAATCCTGTT-3′) (SEQ ID NO:2)^{[29]} and BCoATscrF (5′-GCIGAICATTTCACITGGAAYWS-3′) (SEQ ID NO:3), BCoATscrR (5′-CCTGCCTTTGCAATRTCIACRAANGC-3′) (SEQ ID NO:4).^{[30]} Samples were amplified using a 2× Sensimix™ SYBR No-ROX mix (Bioline, Kampenhout, Belgium) and analyzed with a CFX96 Biorad Detection System (Biorad, Nazareth-Eke, Belgium). Each reaction was performed in triplicate in a 12.0 μl total reaction mixture using 2.0 μl DNA (100 ng/μ1) and 0.5 (total bacteria) or 2.5 μM (butyryl-CoA:acetate-CoA transferase) final primer concentration. The amplification program consisted of one cycle of 95° C. for 10 minutes, followed by 40 cycles of 1 minute at 94° C., 1 minute at 53° C. and 2 minutes at 60° C. (total bacteria) and 1 cycle of 95° C. for 10 minutes, followed by 40 cycles of 95° C. for 30 seconds, 53° C. for 30 seconds, 72° C. for 30 seconds (butyryl CoA:acetate-CoA transferase). A stepwise increase of the temperature from 55° C. to 95° C. (at 5 seconds/0.5° C.) was added to analyze melting curve data for confirmation of the specificity of the reactions. Gene copy numbers were expressed as log 10 values per gram wet weight of feces. Statistical analysis was performed with SPSS Statistics 23 (IBM Corp, New York, United States), using a Kruskall-Wallis test to determine statistical differences in log copy numbers of total Bacteria and butyryl-CoA:acetate-CoA transferase genes among groups.

### In Vitro Digestion and Fermentation.

The different wheat bran fractions were predigested in vitro using a protocol previously described by Wu et al. (2004), which was slightly adapted.^{[31]} First, 1 g substrate was incubated with 1.5 ml 0.03 M HCl (40° C. for 30 minutes) to mimic the initial stages of digestion in the crop. Secondly, the digestion in the proventriculus and gizzard was simulated by incubating the substrate with 3000 U of pepsin in 1 ml 1.5 M HCl (40° C. for 45 minutes). To simulate digestion in the duodenum, 1 ml 1M NaHCO₃ and 3.7 mg pancreatin were added (2 hours at 40° C.). Subsequently, the predigested bran fractions were centrifuged (5 minutes, 5000×g) and washed twice with 20 ml of aqua dest. The resulting pellet was retained and lyophilized. The in vitro fermentations were performed using a nutrient-poor medium described by Moura et al. (2007) with minor modifications, previously described by De Maesschalck et al. (2015).^{[32, 33]} The pH of the medium was adjusted to 6.0. The cecum of 4-week-old Ross 308 broilers was isolated and brought immediately into an anaerobic cabinet (Ruskinn technology, Bridgend, United Kingdom) with 84% N₂, 8% H₂ and 8% CO₂ at 37° C. The lyophilized predigested fractions were supplemented to the nutrient-poor medium to a concentration of 1% (w/v). Non-supplemented medium was used as a control. After 24 hours anaerobic incubation at 37° C., the supernatant was collected after centrifugation (4575 rpm, 10 minutes). The experiment was repeated three times using cecal contents obtained from three different chickens.

### Scfa Quantification.

The method previously described by De Weirdt el al. (2010) was used to quantify the amounts of butyric, propionic and acetic acid.^{[34]} In short, SCFA were extracted from the samples using diethyl ether. Methyl hexanoic acid was added as internal standard. The extracts were analyzed using a GC-2014 gas chromatograph (Shimadzu's, Hertogenbosch, the Netherlands), equipped with a capillary fatty acid-free EC-1000 Econo-Cap column (dimensions: 25 mm×0.53 mm, film thickness 1.2 mM; Alltech, Laarne, Belgium), a flame ionization detector and a split injector. The injection volume was 1 μL and the temperature profile was set from 110° C. to 160° C., with a temperature increase of 6° C./minute. The carrier gas was nitrogen and the temperature of the injector and detector were 100° C. and 220° C., respectively. Statistical analysis was carried out with SPSS Statistics 23, using a one factor ANOVA with Tukey post-hoc test.

Measurement of hilA Expression.

To determine the expression of the hilA gene, the promotor of hilA was cloned in front of luxCDABE genes. The production of light is proportional to the expression level of the gene, which was determined relative to the expression of the housekeeping gene rpsM. The construction of a Salmonella strain carrying a hilA-lux promoter fusion was performed as described previously.^{[35]} A rpsM promoter fusion was constructed similarly by using rpsM specific primers NNNNCTCGAGATCGTTAAGCGTGATGG (SEQ ID NO:5)/NNNNGGATCCCGACACCGTAGATCGAAG (SEQ ID NO:6) for the initial amplification of the rpsM promoter sequence. This resulted in cloning a sequence 214 bp upstream from the rpsM start codon containing rpsM promoter into pCS26, upstream from the lux reporter genes.

To quantify light production by a SE147 strain carrying plasmids either containing hilA-luxCDABE or rpsM-luxCDABE transcriptional fusions, a Fluoroscan Ascent fluorometer (Lab-Systems, Helsinki, Finland) was used. Overnight cultures of SE147 carrying either of the reporter fusion constructs were diluted 1:100 in LB medium, supplemented with supernatant (1:1) derived from the different in vitro fermentation reactions. As a control, LB was supplemented with supernatant (1:1) derived from the control fermentation. Subsequently, the diluted bacterial cultures were grown in microplates at 37° C. Light production was measured automatically every 15 minutes during 15 hours. Statistical analysis was carried out with SPSS Statistics 23, using a two factor ANOVA with chicken as random factor.

### Invasion Assay.

Cells of the human colon carcinoma cell line T84 were seeded in 96-well cell culture plates at a density of 5×10⁵ cells/ml culture medium (Dulbecco's modified Eagle's medium (DMEM), 10% fetal calf serum (FCS), and 2% t-glutamine) and grown for 24 hours at 37° C. and 5% CO₂. Bacterial cultures were grown overnight at 37° C., after which they were diluted 1:100 in LB medium supplemented with supernatant (1:1) obtained from the different fermentation reactions. After 16 hours, the bacterial cultures were centrifuged and the LB medium was replaced by cell medium (DMEM, 10% FCS, 2% t-glutamine) without antibiotics. The suspensions were diluted to a density of 10⁶ CFU/ml. Two hundred μl of these dilutions was transferred onto the cells. Bacterial cells and human cells were brought into contact by centrifugation (10 minutes, 1500 rpm) and incubated together at 37° C. and 5% CO₂. After 1 hour, the T84 cells were rinsed three times with Hanks' Balanced Salt Solution (HBSS, Life Technologies, Paisley, Scotland). Cell medium with 100 μg/ml gentamycin was added and the plates were incubated again for 1 hour at 37° C. and 5% CO₂. Next, the cells were rinsed five times with HBSS (Life Technologies, Paisley, Scotland) and lysed with 0.2% sodium deoxycholate (Sigma) in distilled water. The number of colony-forming units (CFU)/ml was determined by plating 6×20 μl of a ten-fold dilution series of the suspensions onto XLD agar plates. Invasion was calculated as the percent invaded bacteria relative to the initial number of inoculated bacteria. Statistical analysis was carried out with SPSS Statistics 23, using a two factor ANOVA with chicken as random factor.

### Results

Wheat Bran with Average Reduced Particle Size of 278 μm Reduces Cecal Colonization by Salmonella enteritidis SE147

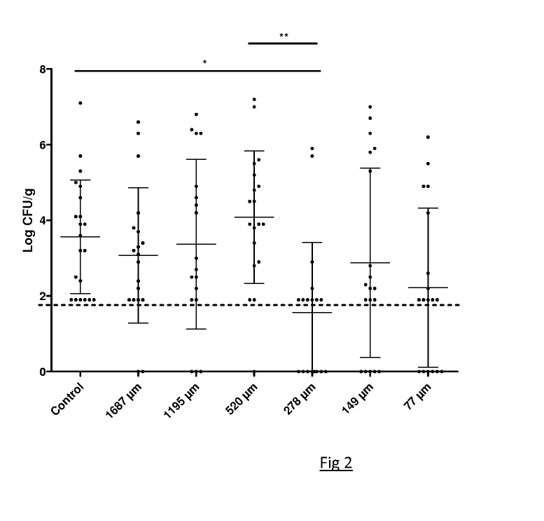

During this experiment, broiler chickens were fed diets supplemented with 1% of different wheat bran fractions and were experimentally infected with Salmonella enteritidis. Before challenge infection, all chickens tested negative for Salmonella. On dpi+1 and dpi+3, cloacal swabs were collected to monitor shedding. All groups shed Salmonella enteritidis to similar levels during the experiment, as no statistical differences could be observed between the different groups (Table 1). On dpi+4, all remaining animals were euthanized and Salmonella counts in the cecum were determined. Animals fed wheat bran with reduced particle size of 278 μm displayed a significantly lower cecal colonization compared to the control group (p=0.036) and the group receiving bran with reduced particle size of 520 μm (p=0.003). In general, a higher number of Salmonella negative caeca could be found in groups fed bran with smaller particle sizes (278 μm, 149 μm and 77 μm) (FIG. 2).

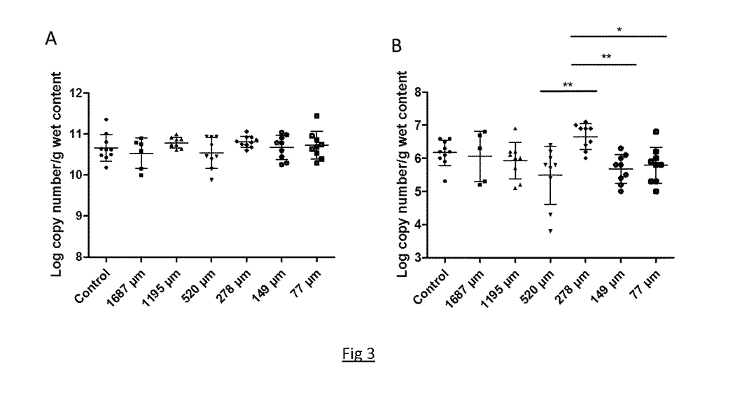

Prior to the challenge infection, ten animals per group were randomly selected and euthanized. Their ceca were sampled and the total number of bacteria and butyryl-CoA:acetate-CoA transferase genes were quantified. No significant difference in the number of total bacteria could be found between the different groups. On the other hand, the number of butyryl-CoA:acetate-CoA transferase gene copies was significantly increased in the group that received bran with particle size of 278 μm compared to bran with particle size of 520 μm (p=0.003), 149 μm (p=0.007) and 77 μm (p=0.03) (FIG. 3).

TABLE 1
Fecal shedding of Salmonella enteritidis strain SE147 after
experimental infection of broilers fed a diet containing different
wheat bran fractions. Chickens were orally inoculated with
10⁶ CFU of Salmonella enteritidis strain SE147 when they were
ten days old. Cloacal swabs were collected at days dpi−1, dpi+1
and dpi+3. The percentages of swabs positive for the Salmonella
enteritidis SE147 challenge strain are shown between brackets.

| | dpi−1 | dpi+1 | dpi+3 |
|---|---|---|---|
| Control | 0/20 | 5/20 (25.0%) | 8/20 (40.0%) |
| 1687 μm | 0/20 | 7/20 (35.0%) | 11/18 (61.1%) |
| 1195 μm | 0/20 | 7/20 (35.0%) | 6/19 (31.6%) |
| 520 μm | 0/20 | 2/20 (10.0%) | 4/19 (21.1%) |
| 278 μm | 0/20 | 4/20 (20.0%) | 6/19 (31.6%) |
| 149 μm | 0/20 | 8/20 (40.0%) | 6/20 (30.0%) |
| 77 μm | 0/20 | 6/20 (30.0%) | 6/19 (31.6%) |

TABLE 2
Proportion of Salmonella positive animals on dpi+4. All chickens
(n = 20) were inoculated with 10⁶ CFU Salmonella enteritidis
(SE147) on day 10 of the experiment. On dpi+4, the chickens were
euthanized and Salmonella counts in cecum were determined.
Significant differences among groups are indicated with different
letters (^{a}, ^{b}) with 0.01 < p ≤ 0.05.

| | Salmonella positive caeca (dpi+4) |
|---|---|
| Control | 20/20 (100%)^{a} |
| 1687 μm | 16/18 (88.9%) |
| 1195 μm | 16/19 (84.2%) |
| 520 μm | 18/19 (94.7%) |
| 278 μm | 11/19 (57.9%)^{b} |
| 149 μm | 15/20 (75.0%) |
| 77 μm | 13/19 (68.4%) |

### Experiment 3: Confirmation of the Effects of Wheat Bran with an Average Reduced Particle Size of 278 μm in a Salmonella Seeder Bird Infection Model

Shedding of Salmonella was monitored by collecting cloacal swabs on dpi-1, dpi+1, dpi+3, dpi+8, dpi+15, dpi+22 and day dpi+29. On dpi+3 and dpi+8, animals fed bran with reduced particle size (278 μm, shed significantly less of the Salmonella challenge strain than the group receiving unmodified bran (1687 μm) (p=0.0001; p=0.0027, respectively). In addition, on dpi+8, animals receiving bran of 278 μm shed significantly less compared to the control group (p=0.0006) (Table 3). On dpi+4, dpi+18 and dpi+32, 20 chickens were euthanized per group and Salmonella counts in cecum were determined by bacteriological analysis. On dpi+4, the number of Salmonella bacteria present in the cecal contents was significantly lower in the group of animals receiving bran with reduced particle size (278 μm) when compared to the control group (p=0.034) and the group receiving unmodified bran (1687 μm) (p=0.022). On dpi+18 and dpi+32, no such differences could be observed.

TABLE 3
Fecal shedding of Salmonella enteritidis strain SE147 after experimental infection
of broilers fed with different wheat bran fractions. One chicken out of five was inoculated
with 10⁸ CFU of Salmonella enteritidis SE147 when they were 10 days old. Cloacal
swabs were collected on dpi − 1, dpi + 1, dpi + 3, dpi + 8, dpi + 15, dpi + 22 and
dpi + 29. The percentage of swabs positive for the Salmonella enteritidis SE147
challenge strain are shown between brackets. Significant differences among groups
within one sampling day are indicated with different letters (^{a}, ^{b}) with p < 0.001.

| | dpi − 1 | dpi + 1 | dpi + 3 | dpi + 8 | dpi + 15 | dpi + 22 | dpi + 29 |
|---|---|---|---|---|---|---|---|
| Control | 0/60 | 15/60 | 16/59 | 23/40 | 20/40 | 7/19 | 6/19 |
| | | (25.0%) | (27.1%) | (57.5%)^{a} | (50.0%) | (36.8%) | (31.6%) |
| 1687 μm | 0/60 | 19/60 | 31/60 | 21/40 | 27/39 | 8/20 | 3/19 |
| | | (31.7%) | (51.1%)^{a} | (52.5%)^{a} | (69.2%) | (40.0%) | (15.8%) |
| 278 μm | 0/60 | 8/60 | 11/60 | 8/40 | 25/40 | 10/20 | 6/20 |
| | | (13.3%) | (18.3%)^{b} | (20.0%)^{b} | (62.5%) | (50.0%) | (30.0%) |

In Vitro Fermentation of Wheat Bran with Reduced Particle Size Leads to an Increased SCFA Production

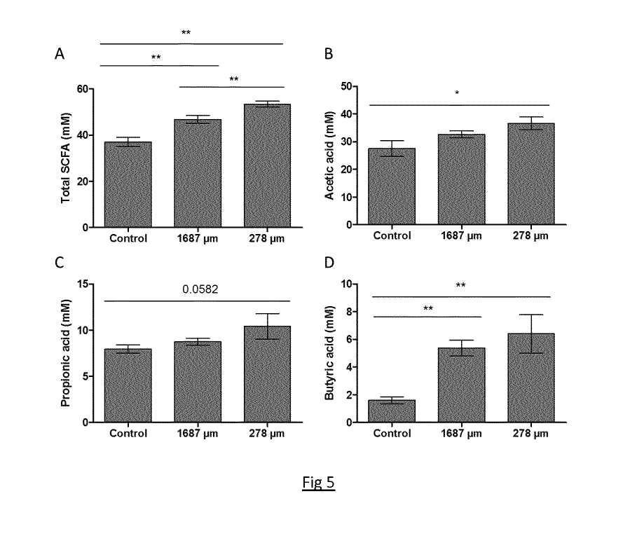

Wheat bran fractions with an average particle size of 278 μm and 1687 μm were fermented in a basal medium for 24 hours using chicken cecal contents. Afterwards, the supernatant was collected in order to quantify the amounts of acetic, propionic and butyric acid produced. The fermentation of unmodified bran (1687 μm) and bran with reduced particle size (278 μm) resulted in higher amounts of total short chain fatty acids when compared to the control fermentation (p=0.008, p=0.001, respectively). In addition, fermentation of bran with reduced particle size (278 μm) resulted in significantly higher levels of SCFA compared to the unmodified fraction (1687 μm) (p=0.042) (FIG. 5, Panel A).

Both the fermentation of unmodified bran (1687 μm) and the particle size reduced fraction (278 μm) resulted in the production of significantly more butyric acid (p=0.004, p=0.001, respectively) compared to the control fermentation FIG. 5, Panel D). The fermentation of bran with average particle size of 278 μm resulted in a significantly higher concentration of acetic acid compared to the control fermentation (p=0.04). No significant differences could be found for propionic acid.

Fermentation Products of Wheat Bran with Reduced Particle Size of 278 μm Downregulate hilA Expression

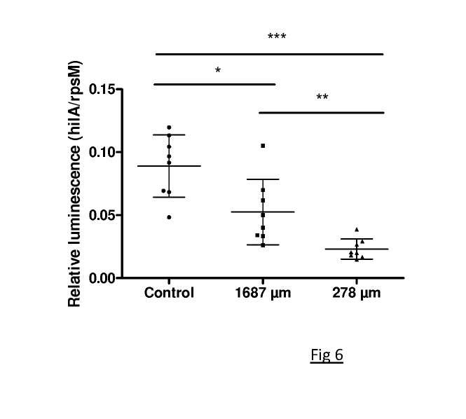

Stationary Salmonella enteritidis (SE147) cultures carrying a plasmid containing either hilA-luxCDABE or rpsM-luxCDABE transcriptional fusions were diluted in LB medium supplemented with supernatant (1:1) derived from the fermentation in which, respectively, no bran (control), unmodified bran (1687 μm) or bran with reduced particle size (278 μm) was added. Two effects could be observed. First, bacteria grown in the presence of fermentation products derived from unmodified bran (1687 μm) or particle size reduced bran (278 μm) showed a reduced hilA expression (p=0.02, p≤0.001, respectively) compared to the control. In addition, bacteria grown in the presence of fermentation products derived from bran with reduced particle size (278 μm) showed a significant decrease in hilA expression when compared to the SE147 strain grown in the presence of fermentation products derived from unmodified bran (1687 μm) (p=0.002) (FIG. 6).

Invasion in Epithelial Cells is Reduced In Vitro when Salmonella is Pretreated with Fermentation Products Derived from Wheat Bran with Reduced Particle Size

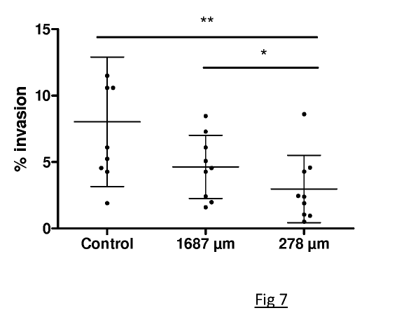

In order to investigate the effect of a diet supplemented with different wheat bran fractions on the ability of Salmonella enteritidis to invade host cells, an invasion assay was performed using Salmonella enteritidis cultures exposed fermentation products derived from unmodified bran (1687 μm), bran with an average reduced particle size of 278 μm, or control fermentation products. Bran size had a significant effect on the percentage of invaded bacteria as pretreatment with fermentation products derived from bran with reduced particle size (278 μm) resulted in a relative reduction in percentage invasion of 63% (p=0.019) when compared to the invasion of Salmonella pretreated with products obtained from the control fermentations. Pretreatment with fermentation products derived from bran with average reduced particle size of 278 μm resulted in a relative reduction in percentage invasion of 36% (p=0.002) in invasion, compared to Salmonella pretreated with products obtained from the fermentation of unmodified bran (1687 μm) (FIG. 7).

### REFERENCES

1. Verspreet, J., et al., “A Critical Look at Prebiotics Within the Dietary Fiber Concept,” Annu. Rev. Food Sci. Technol., 2016. 7:167-90.
2. Stewart, M. L. and J. L. Slavin, “Particle size and fraction of wheat bran influence short-chain fatty acid production in vitro,” Br. J. Nutr., 2009. 102(10):1404-7.
3. Johnson, I. T., “New food components and gastrointestinal health,” Proc. Nutr. Soc., 2001. 60(4):481-8.
4. Guillon, F. and M. Champ, “Structural and physical properties of dietary fibres, and consequences of processing on human physiology,” Food Research International, 2000. 33(3-4):233-245.
5. Moers, K., et al., “Endoxylanase substrate selectivity determines degradation of wheat water-extractable and water-unextractable arabinoxylan.” Carbohydr. Res., 2005. 340(7):1319-27.
6. Kumar, V., et al., “Dietary roles of non-starch polysaccharides in human nutrition: a review,” Crit. Rev. Food Sci. Nutr., 2012, 52(10):899-935.
Jones, J. M., “CODEX-aligned dietary fiber definitions help to bridge the ‘fiber gap’,” Nutr. 1, 2014. 13:34.
8. Roland, N., et al., “Comparative study of the fermentative characteristics of inulin and different types of fibre in rats inoculated with a human whole faecal flora,” Br. J. Nutr., 1995. 74(2):239-49.
9. FAO. “Carbohydrates in Human Nutrition (FAO food and nutrition paper-66),” in Rep. Joint FAO/WHO expert consultation, Apr. 14-18, 1997. Rome.
10. Nyman, M., et al., “Fermentation of dietary fibre in the intestinal tract: comparison between man and rat,” Br. J. Nutr., 1986, 55(3):487-96.
11. Nagy-Szakal, D., et al., “Cellulose supplementation early in life ameliorates colitis in adult mice,” PLoS One, 2013, 8(2):e56685.
12. Brotherton, C. S., et al., “A high-fiber diet may improve bowel function and health-related quality of life in patients with Crohn disease,” Gastroenterol. Nurs., 2014, 37(3):206-16.
13. Hamer, H. M., et al., “Review article: the role of butyrate on colonic function,” Aliment. Pharmacol. Ther., 2008, 27(2): 104-19.
14. Peng, L., et al., “Effects of butyrate on intestinal barrier function in a Caco-2 cell monolayer model of intestinal barrier,” Pediatr. Res., 2007, 61(1):37-41.
15. Leitch, E. C. M., et al., “Selective colonization of insoluble substrates by human faecal bacteria,” Environmental Microbiology, 2007, 9(3):667-679.
16. Stevenson, L., et al., “Wheat bran: its composition and benefits to health, a European perspective,” International Journal of Food Sciences and Nutrition, 2012, 63(8):1001-1013.
17. Maes, C. and J. A. Delcour, “Alkaline hydrogen peroxide extraction of wheat bran non-starch polysaccharides,” Journal of Cereal Science, 2001, 34(1):29-35.
18. Akhtar, M., et al., “Studies on wheat bran Arabinoxylan for its immunostimulatory and protective effects against avian coccidiosis,” Carbohydr. Polym., 2012, 90(1):333-9.
19. Maes, C. and J. A. Delcour, “Structural Characterisation of Water-extractable and Water-unextractable Arabinoxylans in Wheat Bran,” Journal of Cereal Science, 2002, 35(3):315-326.
20. Eeckhaut, V., et al., “Arabinoxylooligosaccharides from wheat bran inhibit Salmonella colonization in broiler chickens,” Poult. Sci., 2008, 87(11):2329-34.
21. Santos, F. B., et al., “Influence of housing system, grain type, and particle size on Salmonella colonization and shedding of broilers fed triticale or corn-soybean meal diets,” Poult. Sci., 2008, 87(3):405-20.
22. “The 2013 joint ECDC/EFSA report on trends and sources of zoonoses, zoonotic agents and food-borne outbreaks published,” Euro. Surveill., 2015, 20(4).
23. Van Immerseel, F., et al., “The use of organic acids to combat Salmonella in poultry: a mechanistic explanation of the efficacy,” Avian Pathol., 2006, 35(3):182-8.
24. Higgins, J. P., et al., “Effect of lactic acid bacteria probiotic culture treatment timing on Salmonella Enteritidis in neonatal broilers,” Poult. Sci., 2010, 89(2):243-7.
25. De Cort, W., et al., “A Salmonella Enteritidis hilAssrAfliG deletion mutant is a safe live vaccine strain that confers protection against colonization by Salmonella Enteritidis in broilers,” Vaccine, 2013, 31(44):5104-10.
26. Jacobs, P. J., et al., “Study of hydration properties of wheat bran as a function of particle size,” Food Chemistry, 2015, 179:296-304.
27. Methner, U., S. Alshabibi, and H. Meyer, “Experimental Oral Infection of Specific Pathogen-free Laying Hens and Cocks with Salmonella Enteritidis strains,” Journal of Veterinary Medicine Series B-Zentralblatt Fur Veterinarmedizin Reihe B-Infectious Diseases and Veterinary Public Health, 1995, 42(8):459-469.
28. Griffiths, R. I., et al., “Rapid method for coextraction of DNA and RNA from natural environments for analysis of ribosomal DNA- and rRNA-based microbial community composition,” Applied and Environmental Microbiology, 2000, 66(12):5488-5491.
29. Hopkins, M. J., et al., “Characterisation of intestinal bacteria in infant stools using real-time PCR and northern hybridisation analyses,” Fems. Microbiology Ecology, 2005, 54(1):77-85.
30. Louis, P. and H. J. Flint, “Development of a semiquantitative degenerate real-time PCR-based assay for estimation of numbers of butyryl-coenzyme A (CoA) CoA transferase genes in complex bacterial samples,” Applied and Environmental Microbiology, 2007, 73(6):2009-2012.
31. Wu, Y. B., et al., “Influence of Three Phytase Preparations in Broiler Diets Based on Wheat or Corn: In vitro Measurements of Nutrient Release,” International Journal of Poultry Science, 2004, 3(7):450-455.
32. Moura, P., et al., “In vitro fermentation of xylo-oligosaccharides from corn cobs autohydrolysis by Bifidobacterium and Lactobacillus strains,” Lwt-Food Science and Technology, 2007, 40(6):963-972.
33. De Maesschalck, C., et al., “Effects of Xylo-Oligosaccharides on Broiler Chicken Performance and Microbiota,” Applied and Environmental Microbiology, 2015, 81(17):5880-5888.
34. De Weirdt, R., et al., “Human faecal microbiota display variable patterns of glycerol metabolism,” Fems. Microbiology Ecology, 2010, 74(3):601-611.
35. Van Immerseel, F., et al., “Medium-chain fatty acids decrease colonization and invasion through hilA suppression shortly after infection of chickens with Salmonella enterica serovar enteritidis,” Applied and Environmental Microbiology, 2004, 70(6) :3582-3587.

1.-9. (canceled)

10. A method for reducing colonization of bacteria belonging to the genus Salmonella in the gut of an animal, the method comprising:
administering to the animal a wheat bran fraction with a mass based average particle size ranging between 273 and 283 μm so as to reduce colonization of bacteria belonging to the genus Salmonella in the gut of an animal.

11. The method according to claim 10, wherein the mass based average particle size of the wheat bran fraction is 278 μm.

12. The method according to claim 10, wherein the animal is a chicken.

13. The method according to claim 12, wherein the chicken is a broiler.

14. The method according to claim 11, wherein the animal is a chicken.

15. The method according to claim 14, wherein the chicken is a broiler.

16. The method according to claim 10, wherein the bacteria belong to the species Salmonella enteritidis.

17. The method according to claim 15, wherein the bacteria belong to the species Salmonella enteritidis.

18. The method according to claim 10, wherein the gut is the cecum.

19. A method for combatting Salmonella infection in an animal or animals, the method comprising:
administering to the animal a feed supplemented with a wheat bran fraction with a mass based average particle size ranging between 273 and 283 μm so as to combat Salmonella infection(s) in the animal(s).

20. The method according to claim 16, wherein said wheat bran fraction maximally represents 5% of the total weight of the feed.

21. The method according to claim 20, wherein the wheat bran fraction represents 1% of the total weight of the feed.


SEQUENCE LISTING (6 sequences)

SEQ ID NO: 1 - DNA, 19 bp, Artificial sequence
  Primer
tcctacgggaggcagcagt

SEQ ID NO: 2 - DNA, 27 bp, Artificial sequence
  Primer
ggactaaccagggtatctaatcctgtt

SEQ ID NO: 3 - DNA, 20 bp, Artificial sequence
  Primer
gcgacatttcactggaayws

SEQ ID NO: 4 - DNA, 25 bp, Artificial sequence
  Primer
  misc_feature (23)..(23): n is a, c, g, or t
cctgcctttgcaatrtcacraangc

SEQ ID NO: 5 - DNA, 27 bp, Artificial sequence
  Primer
  misc_feature (1)..(4): n is a, c, g, or t
nnnnctcgagatcgttaagcgtgatgg

SEQ ID NO: 6 - DNA, 28 bp, Artificial sequence
  Primer
  misc_feature (1)..(4): n is a, c, g, or t
nnnnggatcccgacaccgtagatcgaag